(19) United States
(12) Patent Application Publication
(10) Pub. No.: US 2017/0374599 A1
(43) Pub. Date: Dec. 28, 2017

(54) METHODS AND SYSTEMS FOR MOBILE DEVICE PROFILE MANAGEMENT

(71) Applicant: IMC Holdings, Inc., Rockville, MD (US)

(72) Inventor: John Carvalho, Malvern, PA (US)

(21) Appl. No.: 15/701,382

(22) Filed: Sep. 11, 2017

Related U.S. Application Data
(63) Continuation of application No. PCT/US16/21620, filed on Mar. 9, 2016.
(60) Provisional application No. 62/130,248, filed on Mar. 9, 2015.

(51) Int. Cl. H04W 36/32; H04W 8/20; H04W 36/14; H04W 64/00

(52) U.S. Cl. CPC H04W 36/32; H04W 64/003; H04W 8/205; H04W 36/14

(57) ABSTRACT

According to one aspect, the subject matter described herein includes a method for remote management of a subscription of a mobile device, where the method includes detecting that a mobile device has changed location. In response to detecting that the mobile device has changed location, the method includes determining, based on at least one decision criterion, whether or not to change profile information for the mobile device, and, in response to determining to change profile information, changing the profile information for the mobile device.

### CROSS-REFERENCE TO RELATED FIELDS

This application claims priority to PCT Patent Application No. PCT/US16/21620 filed on Mar. 9, 2016, which claims priority to U.S. Provisional Patent Application No. 62/130,248 filed on Mar. 9, 2015, the contents of both of which are incorporated by reference herein.

### TECHNICAL FIELD

This disclosure relates to the operation of a mobile device. More specifically, it relates methods and systems for management of subscriptions on a mobile device.

### BACKGROUND

Machine-to-machine, or “M2M”, communication may take advantage of the nearly ubiquitous nature of cellular networks to provide a backbone for global M2M communication. To do this, manufacturers may incorporate cellular transceivers, such as are found in mobile telephones, into manufactured goods and equipment for the purpose of M2M communication between equipment. Each cellular transceiver (or piece of equipment containing a cellular transceiver) is associated with a unique identifier, such as an international mobile equipment identifier, or IMEI, which is used by a GSM network to identify valid devices. Mobile telephones are also associated with an international mobile subscriber identifier, or IMSI, which is used to uniquely identify a subscriber of the network. IMSI identifies a user of the equipment and IMEI identifies the equipment itself.

Either or both of these identifiers may be included in the signaling messages associated with a cell phone or other mobile device. The IMSI, for example, may be used to identify and authenticate a subscriber for the purpose of authorizing access to a network or network resources. The IMEI, on the other hand, may be used to whitelist or blacklist certain hardware, such as to bar network access from cell phones that have been reported as being stolen, whether or not the IMSI indicates a valid subscriber.

Typically, each piece of equipment has its own IMEI hardwired into a circuit board, while the IMSI number is stored in a subscriber identity module (SIM), or SIM card, which is connected to a cell phone, for example. In early implementations, SIM cards were removable, but a recent trend is to solder the SIM card to a circuit board of the cell phone in order to make it difficult to transfer the SIM card—and the IMSI contained within—from one piece of equipment to another, such as from an old phone to a new phone. Although there is value in maintaining and monitoring the association or relationship between a subscriber and a particular piece of hardware, e.g., between IMSI and IMEI, the IMEI number has historically been used as a control for devices that have been reported as stolen—a function which can be performed using only the IMEI number without the need to know or maintain any association between IMEI and IMSI.

The same historical trend continues with M2M communication as well. For example, an equipment maker, such as an automobile manufacturing company, may combine a SIM card that includes an IMSI number with cellular equipment that has a unique IMEI and install it into a piece of equipment in a manner that makes the SIM card difficult to separate from the piece of equipment. Conventional uses of such equipment tend to focus on the cell-phone capabilities alone, such as providing an in-car cell phone, providing push-button driver information or roadside assistance, or identifying and disabling stolen vehicles. None of these conventional uses requires an understanding of the association of IMSI and IMEI values.

The addition of hardwired SIM cards to equipment makes possible a number of capabilities, such as the use of IMSI or IMEI values for controlling, monitoring, and tracking inventory. In addition, the use of embedded universal integrated circuit cards, or eUICCs, for storing IMSI data, and the attendant ability of eUICC to be remotely programmed, makes possible an even wider range of capabilities, including the ability to remotely change the subscription on the mobile device in an intelligent manner, as well as the ability to provide fail-safe subscription. Conventional systems and devices do not implement any of these features.

### SUMMARY

The subject matter disclosed herein includes methods and systems for management of subscriptions on a mobile device.

According to one aspect, the subject matter described herein includes a method for remote management of a subscription of a mobile device, where the method includes detecting that a mobile device has changed location. In response to detecting that the mobile device has changed location, the method includes determining, based on at least one decision criterion, whether or not to change profile information for the mobile device, and, in response to determining to change the profile information, changing the profile information for the mobile device.

According to another aspect, the subject matter described herein includes a system for remote change of a subscription of a mobile device. In one embodiment, the system includes a first module having hardware and for detecting that a mobile device has changed location, and a second module for determining, in response to detecting that the mobile device has changed location and based on at least one decision criterion, whether or not to change profile information for the mobile device, and, in response to determining to change the profile information, changing the profile information for the mobile device.

According to yet another aspect, the subject matter described herein includes a method for providing fail-safe subscription of a mobile device, where the mobile device detects that is is unable to register to a network using a presently active subscription. In response, the mobile device collects information about available networks, and determines whether or not to change to a default, “fail-safe” subscription based at least in part on the collected information.

According to yet another aspect, the subject matter described herein includes a system for providing fail-safe subscription of a mobile device. In one embodiment, the system includes a mobile device for operating in a wireless network, where the mobile device contains information for at least one default, “fail-safe” subscription. The mobile device detects that it is unable to register to a network using its presently active subscription, and in response, collects information about available networks and determines whether or not to change to the default subscription based at least in part on the collected information.

The subject matter described herein for mobile device profile management may be implemented in hardware, software, firmware, or any combination thereof. As such, the terms “function” or “module” as used herein refer to hardware, software, and/or firmware for implementing the feature being described.

In one exemplary implementation, the subject matter described herein may be implemented using a computer readable medium having stored thereon executable instructions that when executed by the processor of a computer control the computer to perform steps. Exemplary computer readable media suitable for implementing the subject matter described herein include disk memory devices, chip memory devices, programmable logic devices, application specific integrated circuits, and other non-transitory storage media. In one implementation, the computer readable medium may include a memory accessible by a processor of a computer or other like device. The memory may include instructions executable by the processor for implementing any of the methods described herein. In addition, a computer readable medium that implements the subject matter described herein may be located on a single device or computing platform or may be distributed across multiple physical devices and/or computing platforms.

### BRIEF DESCRIPTION OF THE DRAWINGS

Embodiments of the subject matter described herein will now be explained with reference to the accompanying drawings, wherein the like reference numerals represent like parts, of which:

FIG. 1 is a flow chart illustrating an exemplary process for remote management of mobile device profiles according to an embodiment of the subject matter described herein;

FIG. 2 is a block diagram illustrating an exemplary system for remote management of mobile device profiles according to an embodiment of the subject matter described herein;

FIG. 3 is a flow chart illustrating an exemplary process for providing fail-safe subscription of a mobile device according to an embodiment of the subject matter described herein; and

FIG. 4 is a block diagram illustrating an exemplary system for providing fail-safe subscription of a mobile device according to an embodiment of the subject matter described herein.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

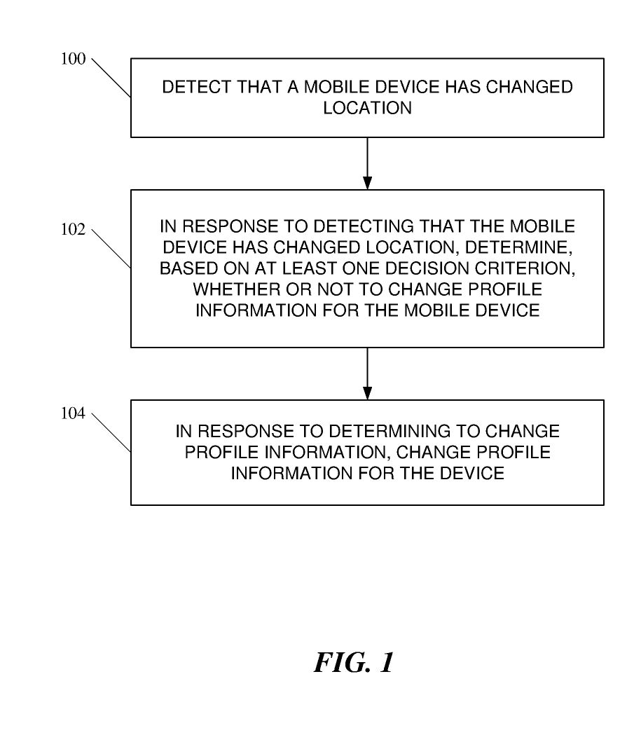

FIG. 1 is a flow chart illustrating an exemplary process for remote management of mobile device profiles according to an embodiment of the subject matter described herein. In the embodiment illustrated in FIG. 1, a method for remote management of a subscription of a mobile device includes, at step 100, detecting that a mobile device has changed location. As used herein, the term “mobile device” includes the radio module, the SIM or eUICC card, and data, applications, or other information stored within the SIM/eUICC card. In response to detecting that the mobile device has changed location, the method includes, at step 102, determining whether or not to change profile information for the mobile device, based on at least one decision criterion, and at step 104, changing the profile information for the mobile device if needed.

In one embodiment, a change of location may be detected by detecting a change in the country in which the mobile device is now operating, the mobile network in which the mobile device is now operation, and/or the geographic location in which the mobile device is now operating. In GSM networks, for example, a change in the mobile country code (MCC), mobile network code (MNC), location area information (LAI), or routing area information (RAI) of the network that is currently serving the mobile device may be used to detect that the mobile device has changed location. Other types of information may also be used to determine a change in location, including information available via network signaling, location information from on-board GPS units, location information based on Wi-Fi access points and location information based on landmark recognition in camera images.

In one embodiment, when a mobile device changes location, the radio transceiver handles the change to a new network, and then notifies the SIM. An applet on the SIM may ask the SIM to provide information about the new network, such as MCC, MNC,and LAI.

The change of location may be detected by the mobile device itself or by another node in the network other than the mobile device, and may be based on information about the mobile device and/or provided by the mobile device. Likewise, the determination whether or not to change profile information for the mobile device may be made by the mobile device or by another node in the network other than the mobile device.

Examples of decision criteria include, but are not limited to: an amount of time that the mobile device has been in the new location; an amount of time that the mobile device was in a previous location; the number or availability of networks in the new location; business agreements related to available networks in the new location; the type of the mobile device; how the mobile device is used; and the type of traffic to and from the mobile device.

Changing the profile information for the mobile device may be accomplished in any number of ways, including but not limited to, activating on the mobile device subscription information that was pre-loaded on the mobile device, or installing and activating on the mobile device subscription information that is downloaded to the mobile device via a mobile network.

Changing the profile information for the mobile device may include changing a network to which the mobile device will subscribe, changing an international mobile subscriber identifier (IMSI) of the user of the mobile device, changing a telephone number associated with the mobile device, changing the availability of services or features to the user of the mobile device, changing the billing plan of the mobile device, and/or changing a data plan of the mobile device. In one embodiment, changing the profile information for the mobile device involves changing the mobile device's subscription to a network that is local to the new location, either to optimize the quality of service and/or to avoid international roaming charges

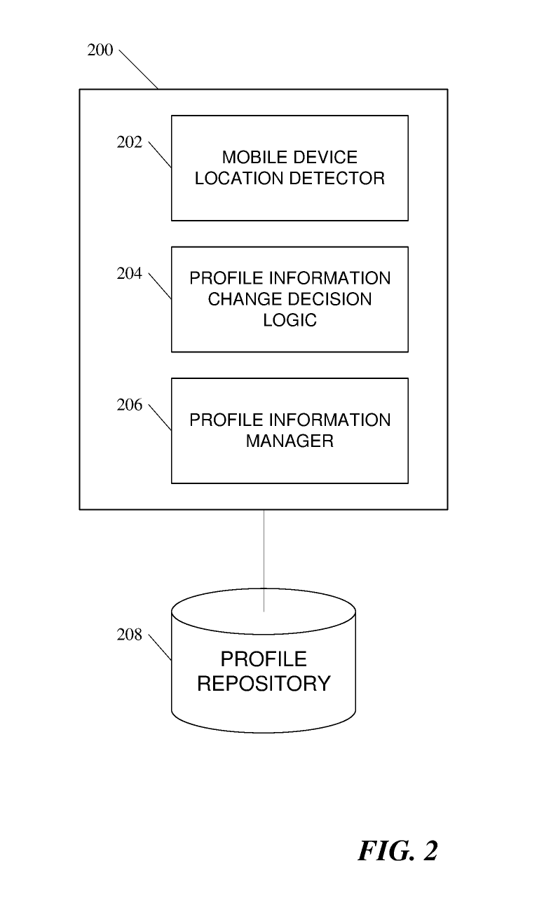

FIG. 2 is a block diagram illustrating an exemplary system for remote management of mobile device profiles according to an embodiment of the subject matter described herein. In the embodiment illustrated in FIG. 2, system 200 includes a first module 202 having hardware and for detecting that a mobile device has changed location, a second module 204 for determining, based on at least one decision criterion, whether or not to change profile information for the mobile device when the device has changed location, and a third module 206 for managing the change of profile information if such a change is needed. The new profile may be retrieved from a profile repository 208, which may be located on the mobile device, not on the mobile device, or distributed both on and off the mobile device.

As described above, detecting that a mobile device has changed location may include detecting a change in the mobile country code (MCC), mobile network code (MNC), or a location area information (LAI) of the network which is currently serving the mobile device. The first module may be a component of the mobile device or a component of a network node other than the mobile device. Likewise, the second module may be a component of the mobile device or a component of a network node other than the mobile device. The same decision criteria as described above may be used.

Changing the profile information for the mobile device may involve downloading a new subscription to the mobile device, which installs and activate the new subscription. Alternatively, the mobile device may locally store multiple subscriptions, in which case changing the profile information for the mobile device involves retrieving a pre-loaded subscription from storage memory within the mobile device without any network data transfer.

The ability to modify subscription data of a mobile device is useful for all of the reasons described above, but another benefit is that, by storing a default, “fail-safe” subscription—e.g., one that is designed to provide basic connection to a network in the most locations world-wide—a mobile phone can choose between subscriptions that provide high value, low cost, high performance, etc., and fail-safe subscriptions that are guaranteed to work everyone, albeit perhaps with few features, low access speed, or high cost. However, there are a few scenarios where blindly switching to a fail-safe subscription is sub-optimal.

One scenario is when the mobile phone finds that it cannot connect to its current network. This may be because the phone has physically relocated out of the operating area of its current network, but it also may be because there was some equipment failure, because a network in which the mobile phone happened to be roaming abruptly terminated a roaming agreement with the home network, or even because the phone is in a tunnel, in a deep parking garage, parked in a faraday cage, etc., or other environment where the signals from the cell phone towers were too weak to be picked up by the mobile device or are drowned out by strong RF interference. In each of these scenarios, the mobile phone needs to decide whether to keep the current subscription or internally activate the fail-safe subscription, and it needs to make this decision without outside help from another node in the network.

Further complicating the picture is that the proper response by the cell phone may be different for each of these scenarios. For example, if the user is travelling to another country, it is likely that a new subscription will need to be necessary, but if the user is stick in traffic in a long tunnel, it would be better to wait and do nothing than to try to switch over to the fail-safe subscription. The same is true of a cell phone user in an area with intermittent but strong RF interference—if the cell phone blindly switched to the fail-safe subscription every time it lost connection to the network, there would likely be frequent and unnecessary subscription changes. In order to address these issues, the subject matter described herein includes a method for providing fail-safe subscription of a mobile device.

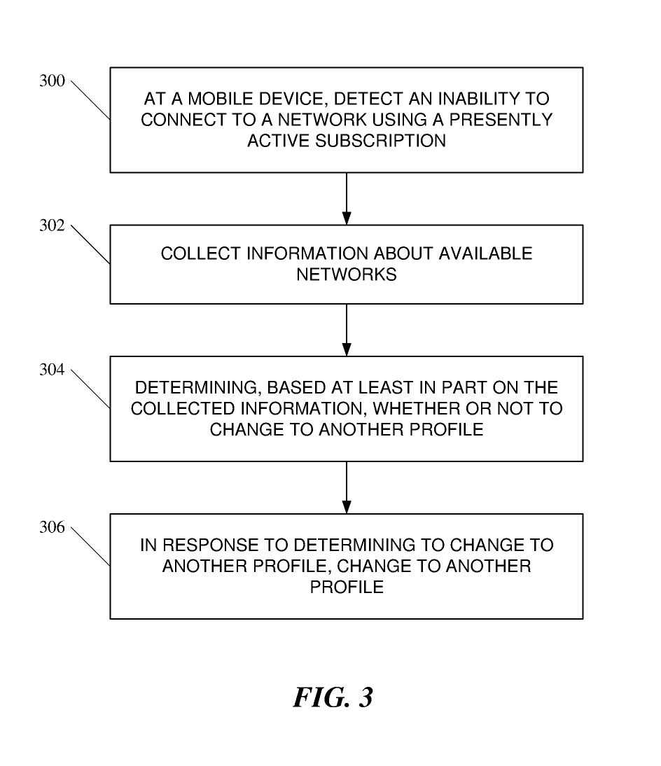

FIG. 3 is a flow chart illustrating an exemplary process for providing fail-safe subscription of a mobile device according to an embodiment of the subject matter described herein. In the embodiment illustrated in FIG. 3, the method includes, at a mobile device: detecting an inability to connect to a network using a presently active subscription (step 300); collecting information about available networks (step 302); and determining, based at least in part on the collected information, whether or not to change to a default subscription (step 304), and changing the default profile if needed (step 306).

In one embodiment, detecting an inability to register to a network includes detecting that the mobile device cannot connect to any network, detecting that the mobile device cannot connect to an allowed network, and/or detecting that the mobile device cannot receive new subscription information, e.g., from a preferred subscription source.

In one embodiment, the decision whether or not to change to a default subscription may be based on a number of factors, including, but not limited to: the amount of time that the mobile device has been unable to register to a network using the presently active subscription; the availability of networks onto which the device may subscribe as a roaming subscriber; the availability of networks onto which the device may subscribe as a native (non-roaming) subscriber; and the ability of the mobile device to receive updated subscription information from a network source.

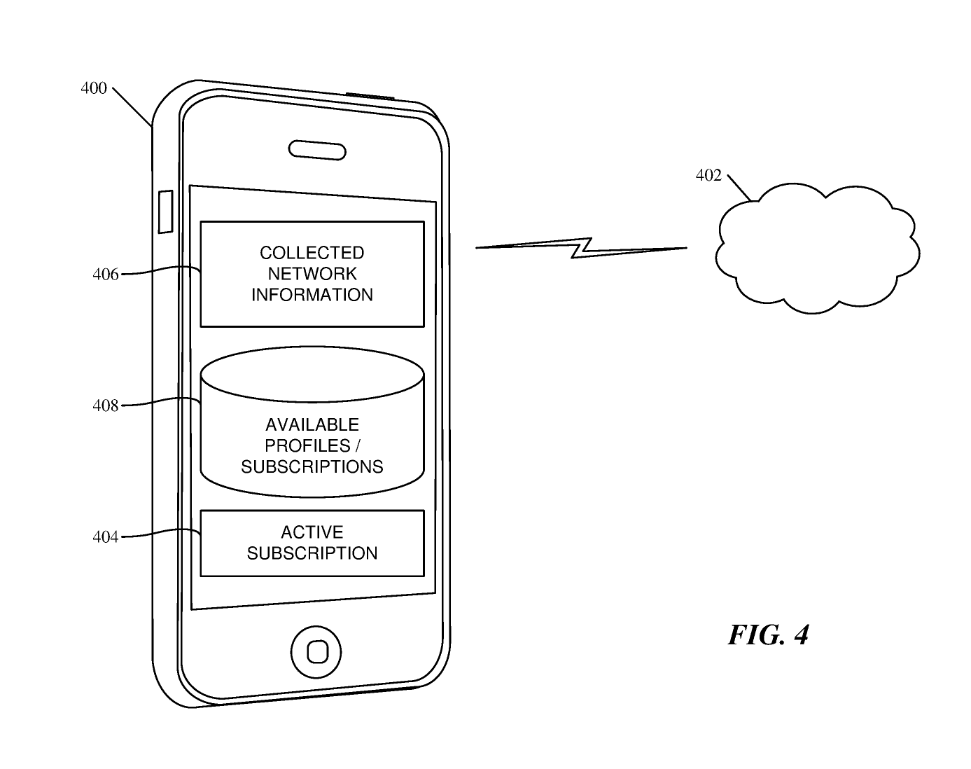

FIG. 4 is a block diagram illustrating an exemplary system for providing fail-safe subscription of a mobile device according to an embodiment of the subject matter described herein. In the embodiment illustrated in FIG. 4, a system for providing fail-safe subscription of a mobile device may include a mobile device 400 for operating in a wireless network 402 and containing information for a default or “fail-safe” subscription. In one embodiment, the mobile device can detect an inability to register to a network using a presently active subscription 404. In response to detecting an inability to register to the network, mobile device 400 can collect information about available networks 406, and determine, based at least in part on the collected information, whether or not to change to a default subscription, according to any of the methods described herein. In one embodiment, the default subscription may be stored within the device 408.

The systems and methods described herein may be embodied in a computer program product for signaling optimization in a wireless network utilizing proprietary and non-proprietary protocols. The computer program product may include a non-transitory computer readable storage medium having computer readable code embodied therewith, the computer readable code comprising computer readable program code configured to perform steps of the processes described above.

In one embodiment, for example, the computer program product may be in the form of a computer system within which a set of instructions, for causing the machine to perform any one or more of the methodologies discussed herein, may be executed. The computer system may include a processor, a memory, a non-volatile memory, and/or an interface device. The computer system can be of any applicable known or convenient type. The components of the computer system can be coupled together via a bus or through some other known or convenient device.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

### RSM Authentication Flow

In conventional systems, SIMs are manufactured under contract between the SIM manufacturer and the Mobile Network Operator (MNO). The SIM Profile is ‘hard coded’ onto SIM at manufacture, and distribution is undertaken by MNO. Encryption keys are in MNO authentication domain. Typically, a provider manufactures SIMS, and the MNO orders SIMs from the preferred SIM provider. The SIMs are shipped to the MNO. Credentials (Ki, OPc, etc.), are encrypted with the MNO TK. Authentication credentials are loaded into a home location register (HLR)/authentication center (AuC).

In a system according to an embodiment of the subject matter described herein, SIMs are manufactured under contract between Device Cloud Networks (DCN) and a SIM/eUICC manufacturer. An MNO provisions the SIM with subscription profiles; the SIM profile is provided by the MNO and created by the SIM manufacturer. Distribution of the SIM is undertaken by DCN or the MNO. MSISDN and IMSI values are provided by the MNO to DCN, which then provides them to the SIM manufacturer along with profile information, which the SIM manufacturer uses to create soft profiles that securely stored within the SIMs. The SIM manufacturer provides DCN with credentials, which are encrypted with DCN TK. Thus, encryption keys are in the DCN authentication domain and require no knowledge of MNO encryption credentials, and the MNO is not involved in the authentication path.

### Signaling and Charging Architecture

In conventional systems, in-network registration signaling is handled explicitly by the home network, and roaming registration signaling is handled by an international signaling connection control part (SCCP) provider under contract by the home network. The home network HLR provides any registration information that may be required.

For in-network charging records, call detail records (CDRs) for in-network voice calls and data sessions are provided by core elements to the home network business support system (BSS). CDRs for in-network SMS are provided by core elements (SMSC or MSC) to the home network BSS. For roaming charging records, CDRs for roaming voice calls are provided by a data clearing house (DCH) to the home network BSS. CDRs for roaming data sessions are provided by data core elements to home network BSS. CDRs for roaming SMS are provided by core elements (SMSC or MSC) to home network BSS.

In conventional systems, in-network traffic is communicated between radio network and the core network, roaming traffic is communicated between the core network and international SCCP provider, and rating information is communicated between the core network and OSS/BSS and between OSS/BSS and a roaming DCH/financial clearing house (FCH) provider.

In a system according to an embodiment of the subject matter described herein, for registration signaling routing, the MNO provides a published global title (GT) for use by a DCN HLR/home subscriber server (HSS). All in-network signaling for relevant MSISDN ranges shall be routed to DCN. The MNO instructs the international SCCP provider to direct relevant signaling for MSISDN and IMSI ranges to the DCN point code. Any registration information required is provided from the DCN HLR.

For core networking capabilities, mobile originated (MO) or mobile terminated (MT) SMS is handled by a DCN SMSC (MT SMS is Home Routed). Data sessions are anchored in a DCN packet gateway (P-GW)/gateway GPRS support note (GGSN). The MNO will need to route to the DCN core from the home network and insert routing for DCN access point names (APNs) into the domain name system (DNS). MT voice calls will be treated by a DCN mobile switching center (MSC).

For in-network charging records, CDRs for in-network voice calls are provided by the MNO BSS to the DCN BSS, CDRs for in-network data sessions are provided by the DCN data core to the DCN BSS, and CDRs for in-network SMS are provided by the DCN SMSC to the DCN BSS. For roaming charging records, CDRs for roaming voice calls are provided by the DCH/Home MNO to the DCN BSS, CDRs for roaming data sessions are provided by the DCN data core to the DCN BSS, and CDRs for roaming SMS are provided by the DCN SMSC to the DCN BSS.

In a system according to an embodiment of the subject matter described herein, the radio network initiates traffic with core network. The MNO sends relevant signaling information for relevant IMSI ranges to the DCN core network for treatment. The MNO sends charging information to the MNO charging gateway (CG) with BSS (normal operation). The MNO sends relevant charging information for relevant IMSI ranges to the DCN BSS. Regarding the roaming control architecture, the MNO provides a GT from its published range to the DCN, and notifies the SCCP provider to route relevant IMSI and MSISDN ranges to the DCN point code. In one embodiment, the MNO notifies the DCH of relevant IMSI ranges to allow direct transfer of relevant information to the DCN. In another embodiment, relevant records for relevant IMSI ranges are sent directly from the DCH to the DCN BSS; records may be sent to the MNO BSS (normal operation), or relevant records for relevant IMSI ranges may be sent from the MNO CG to the DCN BSS. In any case, the MNO core network is not in the routing path.

### Dynamic Assignment of Identities

The systems and methods described herein are suitable for automotive OEMs, which would benefit from connectivity at the factory. Some of the business challenges that must be addressed are that different countries require different connectivity suppliers (MNOs) or suffer expensive roaming, different pricing across multiple markets exacerbates challenge of providing a clear and seamless offer, and multiple SKUs complicate logistics as SIM chips cannot be embedded and tested during manufacturing.

In one embodiment of the systems and methods disclosed herein, DCN supplies programmable SIM chips to be embedded at manufacturing using a single SKU. DCN's dynamic subscription management assigns network profiles after vehicles are delivered to destination markets. DCN provides transparent localized pricing globally for seamless coverage, and can sell to OEMs access to single unified provisioning platform and a common set of workflows to manage connectivity globally.

Some benefits for mass market enablement include that the OEM can embed and test connectivity during manufacturing process and can ship product worldwide using single SIM SKU regardless of final destination. This eliminates regional programs in exchange for a truly global program common across all markets, provides localized pricing cuts costs, reduces ambiguity, and creates a superior customer experience worldwide.

### Example Use Case

In one example use case, a manufacturer in Iceland renovates and supplies classic US cars, with the main target market in the Caribbean, specifically Jamaicans. A reseller in Jamaica partners with the manufacturer, and offers value added services such as tracking of classic cars and associated insurance cost reductions.

The business challenges: different countries require different connectivity suppliers (MNOs) or suffer expensive roaming; different pricing across multiple markets exacerbates challenge of providing a clear and seamless offer; and multiple SKUs complicate logistics as SIM chips cannot be embedded and tested during manufacturing.

The solution: a tracking device is installed into car during renovation, and the device is tested using an Icelandic identity SIM. The car is then shipped to Jamaica. The car's new location is sent to DCN using the Icelandic identity. A Jamaican profile is downloaded securely to SIM over the air from DCN, and the Jamaican profile is activated by command from DCN network.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

What is claimed is:

1. A method for remote management of mobile device profiles, the method including:
detecting that a mobile device has changed location;
in response to detecting that the mobile device has changed location, determining, based on at least one decision criterion, whether or not to change profile information for the mobile device; and
in response to determining to change profile information, changing profile information for the mobile device.

2. The method of claim 1 wherein detecting that a mobile device has changed location includes detecting that the mobile device has changed countries.

3. The method of claim 2 wherein detecting that the mobile device has changed countries includes detecting a change in a mobile country code (MCC) for the mobile device.

4. The method of claim 1 wherein detecting that a mobile device has changed location includes detecting that the mobile device has changed networks.

5. The method of claim 4 wherein detecting that the mobile device includes detecting a change in the mobile network code (MNC) for the mobile device.

6. The method of claim 1 wherein detecting that a mobile device has changed location includes detecting that the mobile device has changed geographic areas. The method of claim 1 wherein detecting that a mobile device has changed geographic areas includes detecting a change in the location area information (LAI) or the routing area information (RAI) for the mobile device.

8. The method of claim 1 wherein the detecting step is performed by the mobile device.

9. The method of claim 1 wherein the detecting step is performed by a network node other than the mobile device.

10. The method of claim 1 wherein the determining step is performed by the mobile device.
